(19) United States
(12) Patent Application Publication
(10) Pub. No.: US 2013/0084859 A1
(43) Pub. Date: Apr. 4, 2013

(54) Exchange of Information Via WIFI Infrastructure Using Wireless Devices

(71) Applicant: Sanjar Azar, Westwood, MA (US)

(72) Inventor: Sanjar Azar, Westwood, MA (US)

(21) Appl. No.: 13/487,746

(22) Filed: Jun. 4, 2012

Related U.S. Application Data
(60) Provisional application No. 61/492,969, filed on Jun. 3, 2011.

(51) Int. Cl. H04W 48/08

(52) U.S. Cl. CPC H04W 48/08
USPC 455/435.1; 455/456.3

(57) ABSTRACT

A system is provided for transmitting information to a user of a mobile communications device. The system includes a database for storing information items associated with a plurality of wireless networks, and a mobile device application operating on a mobile communications device. The mobile device application is for receiving an indication that the mobile communications device is within the operational radius of one of the wireless networks, and causing the transmission of a network identifier associated with one of wireless networks. The system also includes a transmission module for receiving the network identifier from the mobile device application and, in response thereto, transmitting one or more information items associated with an operator of the one of the plurality of wireless networks to the mobile communications device.

### CROSS-REFERENCE TO RELATED APPLICATION

This application claims priority to and the benefit of, and incorporates herein by reference in its entirety, U.S. Provisional Patent Application No. 61/492,969, which was filed on Jun. 3, 2011.

### TECHNICAL FIELD

This invention relates to systems and methods for providing information to a mobile communications device and, in particular, to systems and methods for providing information associated with a wireless network to a mobile communications device.

### BACKGROUND

Many people move throughout the world and even their own local communities without realizing the wealth of information within their surroundings. For example, people travel in their own communities without knowing what buildings may be of historical significance, what shopping center may have a specific store, or whether any store in the shopping center sells a particular product.

In many instances, people rely on brochures, out of date websites or mapping applets on their smartphones to familiarize themselves with their surroundings. These points of information may include tourist/travel information, shopping mall directories/maps or other similar literature. However, these points of information contain limited amounts of (often out of date) information and lack interactivity.

Many entities, such as stores, historical sites, and/or multi-national businesses now utilize distributed networks, such as the Internet and, more particularly, the World Wide Web, to provide the public with useful information. For example, information about a historical site, such as a Civil War battlefield may be disseminated via the World Wide Web and accessed through commercial Internet service providers (ISPs). The World Wide Web also provides the public with countless amounts of other information, such as business data, stock quotes or official government information.

However, a user cannot access this information unless they know or can quickly search for a web address (uniform resource locator, or URL) associated with a particular business. In these cases, it may be difficult to retrieve the correct web page because the URL may be difficult to locate, even with the sophisticated search engines currently available. Also, the web address may be very long which may result in a mistake when entering the web address, or the user may be walking, driving or doing some other task that does not lend itself to simultaneous data entry.

Furthermore, when attempting to find location information about specific locations, a user may not know the “keywords” or other pertinent information in order to extract the desired information relating to that location. For example, a person may want information concerning local vegetation or wildlife, but is unable to define an adequate search to find that specific information. More importantly, the user is not sure if the information received is even relevant to their needs.

Wireless networks have become ubiquitous throughout much of the world, and are especially prevalent in urban and suburban areas. In many cities, most retail, dining and entertainment establishments utilize a wireless network to manage data and/or voice communications. These networks, however, are typically secured such that only those with a key or password can connect to and use the network. This prevents unauthorized users from accessing confidential data and secure systems, and from using the network as a gateway to other networks (e.g., the Internet). The identity of the networks, especially those not meant for public use, is usually either a random value, or, in some cases, a non-obvious name selected by the network operator. In either case, the name typically does not identify the actual entity operating the network.

Separately, the use of smartphones has exploded over the past few years. In addition to conventional cellular services, many of these devices can also communicate via WiFi networks, usually using some form of IEEE 802.11 standard. As a user comes within operational range of a wireless network, her phone can detect the presence of the network and, if the network is unsecured (or if the user or device has an authentication key or password for the network), connect and use the network for various functions. However, even knowing, for example, that a user is within range of a particular network can be valuable, actionable information.

What is needed, therefore, is a technique and supporting systems for recognizing that a mobile device (and it user, by proxy) is at or near a particular network, and using that information to deliver information to the user without sacrificing the security of the network itself.

### SUMMARY OF THE INVENTION

The invention generally relates to obtaining information associated with a specific location using a signal provided by a wireless device at that location. More particularly, the invention relates to techniques and supporting systems for obtaining location-specific information about a particular location using a distributed network that includes the wireless device(s). The present invention provides systems and apparatus for transmitting information corresponding to a wireless network to a mobile communications device (e.g., a cell phone) based, at least in part, on the device's proximity to the source of the network signal. The systems and apparatus enable an establishment that operates or uses the wireless network (or a service provider operating on their behalf) to send information about the establishment and/or its location to the mobile communications device. The information may include, for example, the name of the establishment, advertisements, and offers for products or services. Based on the information received by the mobile communications device, a user of the mobile communications device may be encouraged to visit or contact the establishment and/or conduct electronic commerce.

In one aspect, the invention relates to a method for transmitting information to a user of a mobile communications device. The method includes storing, at a central database, unique wireless network identifiers. The method also includes the step of transmitting, to a mobile communications device, (i) an indication that the communications device is within an operational radius of one (or, in some cases, more) of the wireless networks, and (ii) a network identifier associated with the wireless network. Additional steps include transmitting the network identifier from the mobile communications device to the central database, and, using the network identifier, retrieving from the database information items associated with an operator of the identified wireless network (or networks). The method also includes transmitting the information items to the communications device. In certain embodiments, the information items include an advertisement for goods or services offered by an operator of the wireless networks.

In another aspect, the invention relates to a system for transmitting information to a user of a mobile communications device. The system includes a database for storing information items associated with uniquely identifiable wireless networks. The system also includes a mobile device application operating on a mobile communications device. The mobile communications device receives an indication that the mobile communications device is within the operational radius of one of the wireless networks, and causes the transmission of a network identifier associated with the wireless network. The system also includes a transmission module for receiving the network identifier from the mobile device application and, in response thereto, transmitting information items associated with an operator of the wireless network to the mobile communications device. In certain embodiments, the information items include an advertisement for goods or services offered by an operator of the wireless network.

The foregoing and other objects, features and advantages of the present invention disclosed herein, as well as the invention itself, will be more fully understood from the following description of preferred embodiments and claims, when read together with the accompanying drawings. In the drawings, like reference characters generally refer to the same parts throughout the different views. The drawings are not necessarily to scale, emphasis instead generally being placed upon illustrating the principles of the invention.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1 is a screenshot of a listing of network names discovered on a mobile communications device, in accordance with certain embodiments of the invention.

FIG. 2 is a screenshot in which the network names of FIG. 1 have been replaced with actionable offers, in accordance with certain embodiments of the invention.

FIG. 3 is an illustration of one embodiment of the invention as implemented across a distributed network, such as the Internet or a cell phone network.

FIG. 4 is a schematic illustration of a computer storage and processing device on which various embodiments of the invention may operate.

### DETAILED DESCRIPTION

It is contemplated that devices, systems, methods, and processes of the claimed invention encompass variations and adaptations developed using information from the embodiments described herein. Adaptation and/or modification of the devices, systems, methods, and processes described herein may be performed by those of ordinary skill in the relevant art.

Throughout the description, where devices and systems are described as having, including, or comprising specific components, or where processes and methods are described as having, including, or comprising specific steps, it is contemplated that, additionally, there are devices and systems of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

In various aspects, a system and methods for its use are provided that allow “establishments” (meaning any physical location offering goods or services to others, whether it be retail, dining, lodging, business or personal services, etc.) to send actionable information to a receiver based on the detection of the device near a wireless network operated by or on behalf of the establishment. As used herein, “information” may include data (either formatted or unformatted), offers for products or services, images, text, audio, alerts, emergency information/instructions, video, or any combination thereof. A “receiver” may include a cellular telephone, smart-phone, personal data assistant, tablet PC, laptop, e-reader, automobile-based information system, GPS device, or any device capable of sending and/or receiving information over wired or wireless networks. Location-based information is delivered (in some cases in real-time) from a transmitter (typically a service acting on behalf of a retail sponsor or other provider of goods and services) to the receiver at the “point of contact,” in relative closeness to the retail sponsor and its merchandise. In effect, the technique extends the “point of sale” beyond the physical location of the establishment to the operational radius of the wireless network owned or operated by the sponsoring establishment. While described herein as relating to consumer-based retail information, the same techniques may be used by federal, state and/or local government agencies to broadcast information relating to local events and emergencies. In some cases, the “establishment” may be transitory—e.g., a vehicle or a person that has a portable wireless transmission/access point device, such as a MiFi card or, in other instances, has enabled their smartphone to function as a wireless hotspot. In other cases, the location may be a place that the user visits repeatedly (e.g., their home, office, school, etc.) and be recognized based on a frequently seen wireless ID.

In some embodiments, multiple networks may be associated with a retail chain (e.g., all CVS WiFi networks are associated with CVS) such that the information transmitted to the user is centrally controlled. In other instances, a single network may be associated with a single store, allowing for more localized information to be sent (e.g., coupons for sunscreen at a store near a beach on a sunny day). Further, and especially in larger retail locations (e.g., WallMart, Target, Home Depot, etc.) multiple networks may be established for each location, and individual networks and/or routers with unique service set identifiers (“SSIDs”) may be associated with particular departments (electronics, home and garden, etc.) or even specific products. In some implementations, the larger retail establishments may sell, license, auction or otherwise sub-let the opportunity to broadcast information based on their wireless networks to other entities such as a particular manufacturer or brand, allowing a store such as a Home Depot to gain incremental revenue by allowing a tool manufacturer (e.g., DeWalt) to send coupons for their products to individuals browsing the power tool aisle. As a result, users travelling around various commercial locations will have access to a virtual “digital billboard” of information that is timely and relates to the establishments in their close proximity.

Unlike conventional coupon delivery systems that deliver random product discounts and promotions to a widely dispersed audience, various embodiments of the invention deliver timely and immediate opportunities to shoppers who are in close proximity (hyper-local) to the sponsoring retailer, driving customers into the store but also enabling online purchases and completing the transaction without requiring users to identify their location or the use of other GPS-based systems. For example, conventional geo-location uses triangulation based on device's location relative to cell towers and GPS, which is only accurate to a mile or two. The system and techniques described herein allow a device (and, by extension, its user) to be associated with a location using only a WiFi signal detected by a device-resident application.

The technique takes advantage of a unique identifier (such as an SSID or MAC address of a router) assigned to wireless networks to identify the network and deliver the rich media content and information to a smartphone or other WiFi-enabled device. In one embodiment, an SSID identification applet executes on the device and captures the SSID as it is broadcast from the wireless router/access point. The SSID is then transmitted to a central server using the device's wireless connectivity to the Internet (3G or 4G, for example). At the server, the SSID is used as a lookup key to find information associated with that particular SSID to be delivered back to the device. In some instances, the SSID is encrypted, hashed, or otherwise obfuscated to increase security.

More specifically, each unique identifier registered with and stored on the central server(s) (typically operated by a data transmitter operating on behalf of multiple establishments) corresponds to an establishment's data source for information or other content to be delivered to the user. Users of the applet (typically consumers) may provide their name (either actual name or a username), address, email and other pertinent credentials to activate the applet on their device. In some embodiments, a customer portal allows users to manage privacy settings, provide demographic data, and preference data in order to influence which offers they receive. The applet may be preinstalled on the device or purchased from an “app store.” A unique serial number is assigned to each instance of the applet to facilitate additional tracking and delivery of services. The applet communicates with the server via a transmission server, web server, or other similar network communications server and receives information based on various user preferences in addition to its proximity to a particular network. This unique serial number enables the central server to identify and deliver a unique offer, promotion, or other information to each individual user. Content can be produced, tailored, and delivered immediately, based on demographic information associated with the user and the user's current location.

For the establishments that operate the networks and use the service to deliver information to consumers, an online portal is provided. The portal allows establishments and/or their partners (e.g., marketing partners, content providers, brands, etc.) to create content for distribution to devices in real-time and alter the information and/or delivery parameters for the information based on differing conditions and contexts. In other instances, the content is created off line and provided to the server and stored thereon for subsequent delivery.

The retail or commercial establishments wishing to communicate with consumers may also be provided with software that facilitates the management of the unique identifiers associated with their routers and/or networks, ensuring the uniqueness of the identifiers within the central database and the delivery of content related to a specific WiFi network and location. The establishment may also provide a public IP address assigned to their network by their ISP. Since each IP address is unique on the Internet and roughly correlates to longitude and latitude coordinates, the physical network location can be determined within some reasonable distance threshold. Once registered, the establishment accesses an information configuration portal where promotional material may be designed, for example, from scratch or using pre-designed templates. In some versions, a merchant measurement matrix provides detailed information about the success rate, buy through, peer review, forwarding, and sharing of the information among consumers in real-time.

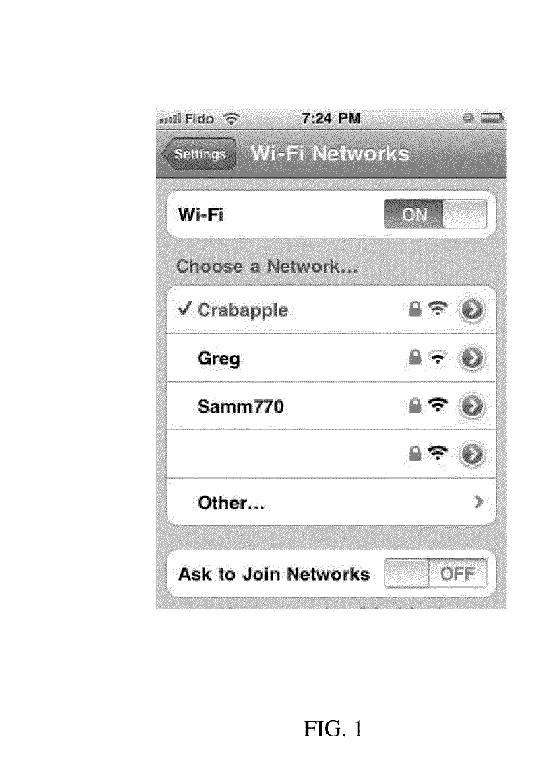

As an example, referring to FIG. 1, when a consumer brings her wireless device within the proximity of a WiFi network, the applet on her device working in the background captures the SSIDs being broadcast by nearby WiFi routers. The consumer may, in some cases, see a listing of wireless networks within range, and, in many cases, the names will be meaningless. In other implementations, the users are not show the network names, but instead are cued (using an auditory signal, vibration, message, or other means) to indicate that they are in proximity to a network. In yet other cases, no indication is provided until the offer message is received and displayed on the phone.

In some embodiments, the network owner/establishment may instead use a signal booster to increase the operational radius of the router and reach additional devices. The device then transmits the SSIDs (via the device's Internet connectivity, typically) to the central server. The server-side system component searches the database using the SSID (or other unique key based thereon) for information and offers relating to that particular network. For example, if the SSID refers to a network operated by a local coffee house, the database may contain information about the coffee house (recognizable name, hours of operation, menu, etc.) and/or one or more offers for free or discounted drinks or food at that coffee house. The content delivered to the consumer can be in any form, such as coupons, percentage off, by one get one free, deal of the day, cross-sell opportunities, etc.

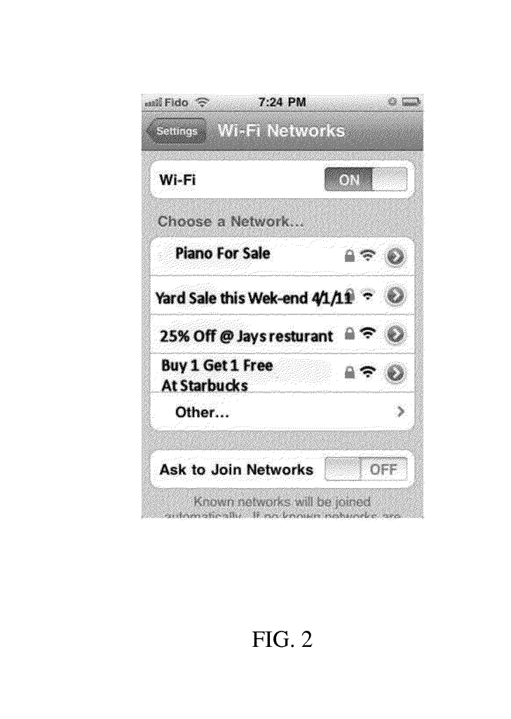

Referring to FIG. 2, in some instances, the listing of wireless networks that was previously meaningless to the consumer is replaced with a list of actionable, recognizable offers from the entities that operate or own the wireless networks.

Once a network (or multiple networks) are identified, the device alerts the user (via sound, vibrations, visual cues, etc.) that there is an offer or other information available from establishments in the vicinity of the user. The user may then select the message (by tapping a touch screen, for example) to establish another connection to the Internet, and a media-rich content page is delivered to the user. At this point, the user can access a variety of media-rich content from the central server. In another instance, the user may chose to view the offers/information at a later time, if, for example, they are driving or otherwise do not have access to their device.

In some embodiments, the system may be used to settle rebates or refunds immediately. For example, a customer purchases an item having a rebate at a location where the consumer's device recognizes a particular network. Using the techniques described above, the user is presented with a content page on which they can enter a specific code, and the rebate can be credited to the consumer's debit card, credit card, or bank account immediately, either by the offering store, or through a third party.

The system may also be used as an additional authentication and/or fraud detection mechanism. Because the system is aware of the location of the WiFi router and a particular serial numbered app at or in close proximity to that router, the system can be deployed as an authentication service for banks, credit card companies, or other similar institutions that track user habits. For example, the system may be used to identify unusual behavior or usage patterns.

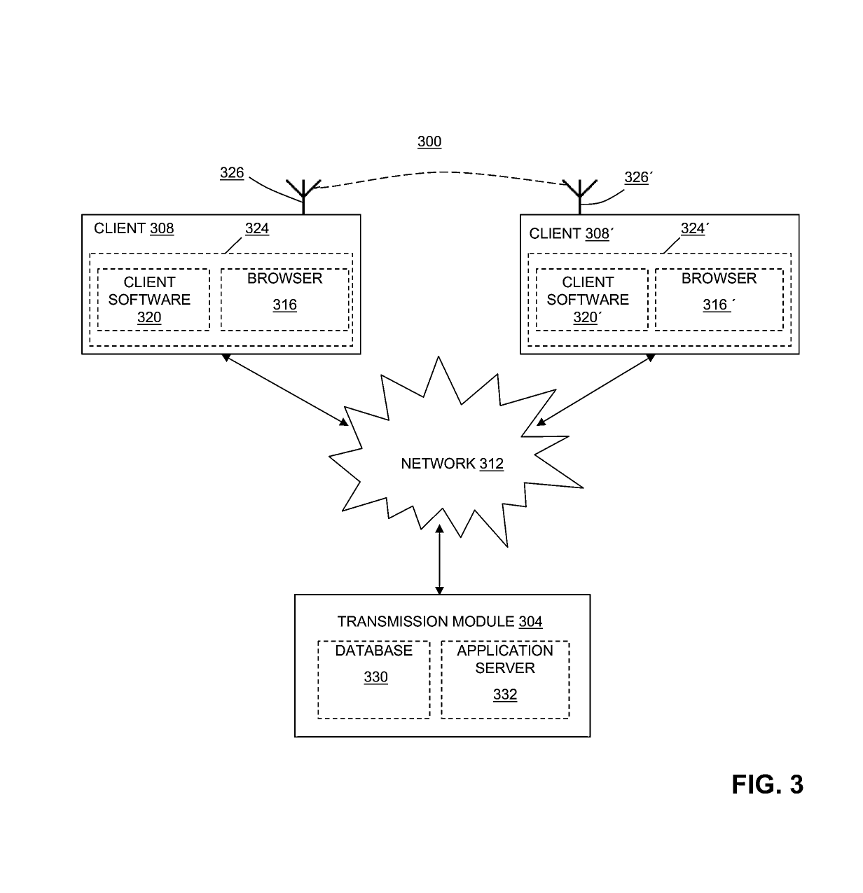

Referring now to FIG. 3, in one embodiment, a wireless information exchange system 300 includes at least one server or transmission module 304, and interacts with and provides its services and functions to at least one client device 308, 308′, generally 308. As shown, the transmission module 304 interacts with two clients 308, 308′, but this is exemplary and for demonstrative purposes, and it is intended that there can be any number of clients 308. The client 308 may be implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MAC OS operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 308 may also be implemented on such hardware devices as a smart or dumb terminal, a point of sale device (POS), network computer, set top box, game player, mobile device, wireless device, wireless telephone, smartphone, personal digital assistant, media (e.g., music and/or video) player, camera, information appliance, workstation, minicomputer, mainframe computer, or any other device with computing functionality. The client 308 may be operated as a general purpose computer or a special purpose hardware device.

Generally, in various embodiments, client 308 may be used or operated by one or more establishments or merchants to provide input and instructions to the system 300. As described above, examples of the types of information that may be exchanged include but are not limited to data (either formatted or unformatted), advertisements, offers for products or services, images, text, audio, alerts, emergency information/instructions, video, or any combination thereof. Client 308 may be operated by individuals acting on behalf of the merchant (e.g., employees or third-party marketing consultants) or the individual merchant herself.

Client 308′ is generally a cell phone or other portable computing device operated by a user. As depicted, client 308 and client 308′ include antennas 326, 326′ for direct wireless communication. For example, as the user walks by an establishment, the clients 308, 308′ may communicate through a wireless network operated by the establishment.

In some embodiments, a client device 308 includes a web browser 316, client software 320, or both. The web browser 316 allows the client 308 to request a web page or other downloadable program, applet, or document (e.g., from the transmission module 304) with a web page request. One example of a web page is a data file that includes computer-executable or interpretable information, graphics, sound, text, and/or video, that can be displayed, executed, played, processed, streamed, and/or stored and that can contain links, or pointers, to other web pages. In one embodiment, a user of the client 308 manually requests a web page from the transmission module 304. Alternatively, in another embodiment, the client 308 automatically makes requests with the web browser 316. Examples of commercially available web browser software 316 are INTERNET EXPLORER, offered by Microsoft Corporation, CHROME, offered by Google Corporation, SAFARI, offered by Apple Corporation, or FIREFOX offered by the Mozilla Foundation.

In some embodiments, the client 308 also includes client software 320. The client software 320 provides functionality to the client 308 that may be needed by the client device to execute one or more functions within the system 300. The client software 320 may be implemented in various forms, for example, it may be in the form of a Java applet or program that is downloaded to the client 308 and runs in conjunction with the web browser 316. The client software 320 also may be in the form of a standalone application, implemented in a multi-platform language such as .Net or Java, or in native processor executable code. In one embodiment, if executing on the client 308, the client software 320 opens a network connection to the transmission module 304 over the communications network 312 and communicates via that connection to the transmission module 304. The client software 320 and the web browser 316 may be part of a single client-server interface 324; for example, the client software can be implemented as a “plug-in” to the web browser 316 and/or code that is downloaded and run within the framework of the web browser 316.

In one embodiment, the client software 320 is software that is specifically implemented for the purpose of implementing functions described herein. In another embodiment, the client software 320 includes other functionality, as well as implementing functions described here. For example, the client software 320 may be included as part of an operating system, application server, mobile application (or “app”), application program, and/or other software. The client software 320 may perform tests when other functions of such operating systems, application servers, and/or application programs are not using the full capacity of the device.

A communications network 312 connects the clients 308 with the transmission module 304. The communication may take place via any media such as standard telephone lines, cell phone networks, LAN or WAN links (e.g., T1, T3, 56 kb, X.25), broadband connections (ISDN, Frame Relay, ATM), wireless links (802.11, Bluetooth, cellular, etc.), and so on, in any suitable combination. Preferably, the network 312 can carry TCP/IP protocol communications, and HTTP/HTTPS requests made by the web browser 316 and the connection between the client software 320 and the transmission module 304 may be communicated over such TCP/IP networks. The type of network is not a limitation, however, and any suitable network may be used. Non-limiting examples of networks that can serve as or be part of the communications network 312 include a wireless or wired Ethernet-based intranet, a local or wide-area network (LAN or WAN), and/or the global communications network known as the Internet, which may accommodate many different communications media and protocols.

The transmission module 304 interacts with clients 308. The transmission module 304 is preferably implemented on one or more server class computers that have sufficient memory, data storage, and processing power and that run a server class operating system (e.g., SUN Solaris, GNU/Linux, and the MICROSOFT WINDOWS family of operating systems). Other types of system hardware and software than that described herein may also be used, depending on the capacity of the device and the number of users and the size of the user base. For example, the transmission module 304 may be implemented on, or may be part of, a logical group of one or more servers such as a server farm or server network. As another example, there may be multiple transmission modules 304 that may be associated or connected with each other, or multiple servers could operate independently, but with shared data. In a further embodiment and as is typical in large-scale systems, the application software may be implemented in components and/or subgroups, with different components and/or subgroups running on different server computers, on the same server, or some combination.

As depicted, the transmission module 304 includes a database 330 for storing and accessing information, and an application server 332 for executing instructions associated with the information transmitted to and from the clients 308. In general, the database 330 stores information provided by the one or more establishments, such as the name(s) of the establishment(s), offers for products or services, and advertisements. The information may be transmitted to and from the database 330 to the clients 308, using the network 312, in accordance with instructions received from the application server 332.

Those skilled in the art will appreciate that various implementations of the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote computer storage media including memory storage devices.

In some cases, relational (or other structured) databases may provide data storage and management functionality, for example as a database management system or a database server which stores data related to the services and consumers utilizing the service. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

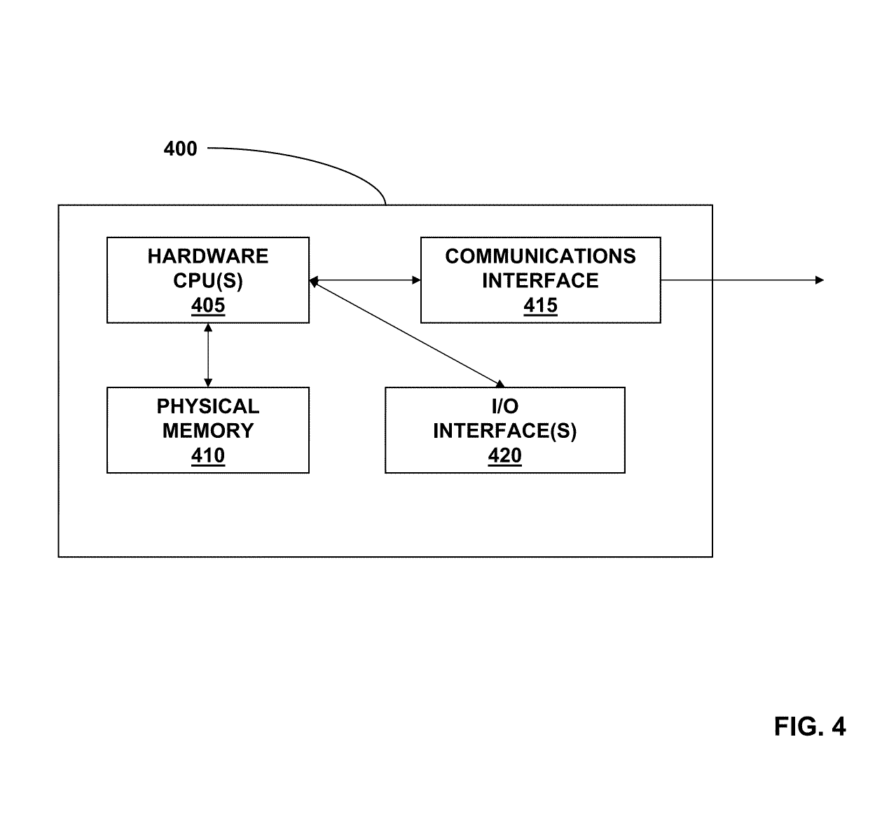

Referring to FIG. 4, a computer system may include a general purpose computing device 400 in the form of a computer including a processing unit 405, a system memory 410, and a system bus that couples various system components including the system memory to the processing unit.

Computers typically include a variety of computer readable media that can form part of the system memory 410 and be read by the processing unit 405. By way of example, and not limitation, computer readable media may include computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, or another operating system of platform.

At a minimum, the memory 410 includes at least one set of instructions that is either permanently or temporarily stored. The processor 405 executes the instructions that are stored in order to process data. The set of instructions may include various instructions that perform a particular task or tasks. Such a set of instructions for performing a particular task may be characterized as a program, software program, software, engine, module, component, mechanism, or tool.

The system may include a plurality of software processing modules stored in a memory as described above and executed on the computer 400. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, RUM and/or JavaScript, for example. Further, it is not necessary that a single type of instruction or programming language be utilized in conjunction with the operation of the system and method of the invention. Rather, any number of different programming languages may be utilized as is necessary or desirable.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner via, for example, a communications interface 415. Additionally, it is appreciated that each of the processor and/or memory may be composed of different physical pieces of equipment.

A user may enter commands and information into the computer through one or more user device interfaces 420 that communicate with input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices (not shown) may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Although internal components of the computer are not shown, those of ordinary skill in the art will appreciate that such components and the interconnections are well known. Accordingly, additional details concerning the internal construction of the computer need not be disclosed in connection with the present invention.

While the invention has been particularly shown and described with reference to specific embodiments, it should be understood by those skilled in the area that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for transmitting information to a user of a mobile communications device, the method comprising:
storing, at a central database, a plurality of unique identifiers, each identifier representing one of a plurality of wireless networks;
receiving, at a mobile communications device, (i) an indication that the communications device is within an operational radius of one of the plurality of wireless networks, and (ii) a network identifier associated with the one of the plurality of wireless networks;
transmitting the network identifier from the mobile communications device to the central database;
using the network identifier, retrieving from the database one or more information items associated with an operator of the one of the plurality of wireless networks; and
transmitting the one or more information items to the communications device.

2. The method of claim 1 wherein the information items comprise an advertisement for goods or services offered by an operator of the one of the plurality of wireless networks.

3. A system for transmitting information to a user of a mobile communications device, the system comprising:
a database for storing information items associated with a plurality of wireless networks, each wireless network being uniquely identified within the database;
a mobile device application operating on a mobile communications device for receiving an indication that the mobile communications device is within the operational radius of one of the plurality of wireless networks and causing the transmission of a network identifier associated with the one of the plurality of wireless networks; and
a transmission module for receiving the network identifier from the mobile device application and, in response thereto, transmitting one or more information items associated with an operator of the one of the plurality of wireless networks to the mobile communications device.

4. The system of claim 3 wherein the information items comprise an advertisement for goods or services offered by an operator of the one of the plurality of wireless networks.

5. A system for displaying location-specific information, the system, comprising:
a wireless transceiver device for:
(i) receiving location-specific service set identifiers from at least one wireless router, (ii) transmitting the location-specific service set identifiers via a distributed network to a database storing information items associated with the service set identifiers, and (iii) receiving, from the database, location-specific information about the location based on the service set identifiers.

6. The system of claim 5 further comprising a display device for displaying the location-specific information.

7. The system of claim 6 wherein the display device further comprises an application residing on the device for displaying content associated with the location-specific information.

8. The system of claim 7 wherein the content comprises one or more of web pages, messages, and dynamic content.
